(19) United States
(12) Patent Application Publication
(10) Pub. No.: US 2008/0202676 A1
(43) Pub. Date: Aug. 28, 2008

(54) METHOD FOR MANUFACTURING MULTILAYER PRINTED WIRING BOARD

(76) Inventors: Yukihiro UENO, Hiroshima (JP); Hiroaki OKADA, Hiroshima (JP)

Correspondence Address: BIRCH STEWART KOLASCH & BIRCH, PO BOX 747, FALLS CHURCH, VA, 22040-0747, US

(21) Appl. No.: 12/038,634

(22) Filed: Feb. 27, 2008

(30) Foreign Application Priority Data
Feb. 28, 2007 (JP) 2007-049898

(51) Int. Cl. B32B 38/10; C09J 177/06; C09J 173/00

(52) U.S. Cl. 156/247

(57) ABSTRACT

In one embodiment, an inner layer pattern formation step of patterning a conductor layer of an inner layer base material to form an inner layer circuit pattern of an inner layer circuit pattern portion and a lead pattern of a lead pattern portion, a resin film affixing step of affixing a resin film to the lead pattern portion, an outer layer base material layering step of layering/fastening to the inner layer base material an outer layer adhesive layer disposed corresponding to the inner layer circuit pattern portion and an outer layer conductor layer disposed corresponding to the inner layer base material, an outer layer pattern formation step of patterning the outer layer conductor layer to form an outer layer circuit pattern portion corresponding to the inner layer circuit pattern portion, and a resin film peeling step of peeling away the resin film from the lead pattern portion, are provided.

### CROSS-REFERENCE TO RELATED APPLICATION

This application claims priority under 35 U.S.C. § 119(a) on Japanese Patent Application No. 2007-049898 filed in Japan on Feb. 28, 2007, the entire contents of which are hereby incorporated by reference.

### BACKGROUND OF THE INVENTION

1. Field of Invention

The present invention relates to a method for manufacturing a printed wiring board used in an electronic device or the like, and a multilayer printed wiring board provided with a flexible inner layer base material having an inner layer circuit pattern portion and a lead pattern portion, and an outer layer base material having an outer layer circuit pattern portion layered on the inner layer circuit pattern portion.

2. Related Art

In portable electronic devices such as video cameras and digital cameras, it is necessary to arrange many electronic components in a small internal space, and connect these electronic components by wiring them to each other.

Conventionally, hard printed wiring boards are connected to each other using connectors and cables, but with the object of reliability and controlling impedance of the connections, and reducing volume, multilayer printed wiring boards have been proposed in which a cable portion (a printed wiring board that is flexible and can be bent) and a mounting portion (a hard printed wiring board) are configured as a single printed wiring board.

With respect to cable portions that require flexibility, in order to perform mounting of electronic components or installation to a case, handling is easier when a mounting portion where electronic components are mounted at least has some degree of rigidity, so it is necessary for the multilayer printed wiring board to have both flexibility and rigidity. Thus there are problems such as that the manufacturing process becomes complicated, and stress occurs at a border between a flexible portion and a rigid portion.

Following is a description of, with reference to FIGS. 11 to 16 (Conventional Example 1), FIGS. 17 and 18 (Conventional Example 2), and FIG. 19 (Conventional Example 3), a method for manufacturing a conventional multilayer printed wiring board that has a portion having flexibility and used as a cable or the like (referred to below as a flexible portion), and a portion that has more conductor layers than the flexible portion, and is rigid compared to the flexible portion, and is a portion where mainly mounting of electronic components are performed (referred to below as a multilayer portion), in a single printed wiring board. Such a multilayer printed wiring board is commonly called a flex-rigid or a rigid-flex printed wiring board.

In order to simplify the drawings and the description, by way of example, a description is given of a multilayer printed wiring board with a configuration in which the multilayer portion has a total of four layers, and the flexible portion has one layer, but the processing procedure is the same in the case of a multilayer printed wiring board with a greater number of layers.

FIG. 11 is a cross-sectional view that shows the overall configuration of an inner layer base material applied in the method for manufacturing a multilayer printed wiring board according to Conventional Example 1.

An inner layer base material 110 is configured with a flexible inner layer insulating base material 111 that serves as an inner layer core, and inner layer conductor layers 112 and 113 formed on both faces of the inner layer insulating base material 111. The inner layer insulating base material 111, for example, is an insulating resin film such as a polyimide, polyether ketone, or crystal polymer. Also, the inner layer conductor layers 112 and 113 are formed by layering, for example, a conductor material (metal layer) such as copper foil on the surface of the inner layer insulating base material 111.

A portion of the inner layer base material 110 is a flexible portion employed as a cable. Also, the inner layer base material 110 is commercially available as double-sided flexible wiring board material.

FIG. 12 is a cross-sectional view that shows an overall state in which a resist mask has been formed in order to form the inner layer circuit pattern portion and the lead pattern portion in the inner layer base material shown in FIG. 11. FIG. 13 is a cross-sectional view that shows an overall state in which the inner layer circuit pattern portion and the lead pattern portion have been formed in the inner layer base material, employing the resist mask shown in FIG. 12.

An etching resist is applied to the surface of the conductor layers 112 and 113 by employing a circuit pattern formation method (such as a photolithography method), thus forming an etching resist 140 that corresponds to a circuit pattern (FIG. 12).

Next, by etching (patterning) the conductor layers 112 and 113 with a suitable etchant, an inner layer circuit pattern 112c, an inner layer circuit pattern 113c, and a lead pattern 112t are formed, and then the etching resist 140 is peeled away (FIG. 13). When copper foil is used for the conductor layers 112 and 113, cupric chloride, ferrous chloride, or the like is employed as the etchant.

The inner layer circuit pattern 112c and the inner layer circuit pattern 113c constitute an inner layer circuit pattern portion Acf. The lead pattern 112t constitutes a lead pattern portion At (flexible portion) extended from the inner layer circuit pattern portion Acf. That is, by patterning the conductor layers 112 and 113 of the inner layer base material 110, the inner layer circuit pattern portion Acf and the lead pattern portion At are formed (inner layer pattern formation step).

In the inner layer circuit pattern portion Acf, an outer layer circuit pattern (conductor layer 122) is formed by layering in a subsequent step, thus configuring a multilayer portion (layered circuit pattern portion Acs/outer layer circuit pattern portion Ace (see FIG. 15)).

The lead pattern 112t is a lead pattern (flexible portion employed as a cable) for making an external connection, and is extended from the inner layer circuit pattern 112c (the inner layer circuit pattern portion Acf). Formed at the tip of the lead pattern 112t is an exposed portion 112tt that acts as a terminal portion/land portion. Also, surface treatment such as gold plating or the like is performed on the exposed portion 112tt in a subsequent step, so that the exposed portion 112tt functions as a connection terminal that is connected to outside. That is, the exposed portion 112tt is a portion drawn out as a connection terminal of the lead pattern portion At of the completed multilayer printed wiring board.

A discarded plate portion Ah that is ultimately cut is disposed around the circumference of the inner layer circuit pattern portion Acf (layered circuit pattern portion Acs) and the lead pattern portion At.

FIG. 14 is a cross-sectional view that shows an overall state in which an insulating protective film has been formed on the inner layer base material shown in FIG. 13.

After an inner layer pattern formation step, a coverlay 114 that serves as an insulating protective film is fastened to conductor layer portions other than the exposed portion 112tt (the inner layer circuit pattern 112c, the inner layer circuit pattern 113c, and the lead pattern 112t).

Ordinarily, the same material as the insulating resin film of the inner layer insulating base material 111, with the same thickness, is used as the coverlay 114. The coverlay 114 includes a coverlay base material 114a and a coverlay adhesive layer 114b. Also, when necessary, a surface treatment such as gold plating or the like is performed on the exposed portion 112tt (terminal/land portion).

FIG. 15 is a cross-sectional view that shows an overall state in which the outer layer base material has been layered on the inner layer base material shown in FIG. 14. FIG. 16 is a plan view that shows the state in FIG. 15 when viewed from above. In FIG. 16, for the sake of a more legible drawing, circuit patterns, resists, holes, and the like are not shown.

Next, an outer layer base material 120, and an interlayer adhesive layer 125 that fastens the outer layer base material 120 to the inner layer base material 110, are prepared. The outer layer base material 120 is configured with an outer layer insulating base material 121 that serves as an outer layer core, and a conductor layer 122 formed on the surface of the outer layer insulating base material 121.

Employed as the outer layer base material 120 is, for example, a single-sided wiring board material that is ordinarily commercially available. In this material, copper foil (the conductor layer 122) is layered on an insulating material (the outer layer insulating base material 121) of glass epoxy or polyimide.

The interlayer adhesive layer 125 is layered on a face where the outer layer base material 120 faces the inner layer base material 110, and with a layering press or the like, the outer layer base material 120 is layered and fastened to the inner layer base material 110 (base material layering step; FIG. 15).

A portion that corresponds to the layered circuit pattern portion Acs in the outer layer base material 120 layered on the inner layer base material 110 becomes the outer layer circuit pattern portion Ace with the formation of an outer layer circuit pattern (not shown) by patterning of the conductor layer 122 (outer layer pattern formation step).

After the base material layering step, applying a multilayer printed wiring board manufacturing method that includes through hole processing, panel plating, outer layer circuit pattern formation, solder resist formation, silk printing, and surface treatment such as plating or rust-proofing treatment, steps advance until immediately before outer shape processing.

In the multilayer printed wiring board in a completed state, it is necessary that the lead pattern portion At (flexible portion) is exposed to the outside. That is, it is necessary that a portion that corresponds to the lead pattern portion At of the outer layer base material 120 layered on the inner layer base material 110 in the base material layering step is removed prior to completion of the multilayer printed wiring board. Also, the lead pattern portion At has a border position BP of a border with the multilayer portion (layered circuit pattern portion Acs/outer layer circuit pattern portion Acf/outer layer circuit pattern portion Ace). Note that the multilayer portion is harder than the flexible portion, because the inner layer base material 110 and the outer layer base material 120 have been layered.

Accordingly, in order to facilitate removal of the outer layer base material 120 in a region that corresponds to the lead pattern portion At, a separation slit 120g is formed in advance prior to layering at a portion that corresponds to the border position BP of the outer layer base material 120, and the interlayer adhesive layer 125 is removed in advance in the region that corresponds to the lead pattern portion At.

That is, the inner layer base material 110 is not fastened to the outer layer base material 120 in the portion that becomes the flexible portion due to formation of the separation slit 120g and removal of the interlayer adhesive layer 125 in the region corresponding to the lead pattern portion At. Accordingly, by performing outer shape processing (outer circumferential edge formation) of the flexible portion/multilayer portion (multilayer printed wiring board) in an outer circumferential edge formation step, which is a subsequent step, it is possible to remove the outer layer base material 120 in a portion that corresponds to the lead pattern portion At.

As shown in FIG. 16, at cutting line DL, outer shape processing is performed (outer circumferential edge formation step). The separation slit 120g extends slightly to the outside of the cutting line DL. Thus, when outer shape processing is performed by perforation with a metal die or the like corresponding to the cutting line DL, the outer layer base material 120 is separated into two portions at the separation slit 120g, the two portions being a multilayer portion side and a flexible portion side.

The outer layer base material 120 (outer layer circuit pattern portion Ace) of the multilayer portion (layered circuit pattern portion Acs) side is fastened to the inner layer base material 110 (inner layer circuit pattern portion Acf) with adhesive, while the outer layer base material 120 of the flexible portion (lead pattern portion At) side is only closely fitted physically with pressure and heat in a step during substrate layering because there is no interlayer adhesive layer 125. The outer layer base material 120 superimposed on the flexible portion (lead pattern portion At) is peeled away with a jig or by hand, and thus the multilayer printed wiring board is completed.

Methods for layering outer layer base material on inner layer base material after slit is formed in advance in order to separate unnecessary outer layer base material are disclosed in, for example, JP H7-106765A, JP H9-331153A, JP 2003-31950A, and JP 2006-210873A.

FIG. 17 is a cross-sectional view that shows an overall state in which an outer layer circuit pattern has been formed by layering the outer layer base material on the inner layer base material, in a method for manufacturing a multilayer printed wiring board according to Conventional Example 2.

Other than Conventional Example 1, a method cited as Conventional Example 2 has been proposed in which a slit is not formed in advance in the outer layer base material. For example, in such a method, after layering the outer layer base material, only the outer layer base material is cut with a laser, or the outer layer base material is mechanically peeled away. When the outer layer base material is mechanically peeled away, the cutting position is likely to become uncertain, so it is known to perform some measure such that the outer layer base material is peeled away at a desired location. Specifically, processing is performed up to the base material layering step shown in FIG. 15 with the same procedure as in Conventional Example 1. Unlike in the case of Conventional Example 1, in Conventional Example 2 a separation slit 120g is not formed.

In Conventional Example 2, as a means of assisting cutting of outer layer base material 120, when a conductor layer 122 is patterned to form an outer layer circuit pattern 122c, thus configuring an outer layer circuit pattern portion Ace (outer layer pattern formation step), the conductor layer 122 is patterned so that two border delineating patterns 122cg are formed that sandwich a border position BP. It is also possible to have only any single border delineating pattern 122cg. After the outer layer pattern formation step, processing such as solder resist formation, silk printing, and the like are performed.

FIG. 18 is a plan view that shows, viewed from above, a state in which a cutting slit has been formed after configuring the outer layer pattern portion in FIG. 17. In FIG. 18, for the sake of a more legible drawing, circuit patterns, resists, holes, and the like are not shown.

After the outer layer pattern formation step, a cutting slit 120f is formed by center hole processing performed at the circumference of the flexible portion, except for border position BP of the lead pattern portion At (flexible portion) and the multilayer portion (layered circuit pattern portion Acs/inner layer circuit pattern portion Acf/outer layer circuit pattern portion Ace). Due to formation of the cutting slit 120f, the cutting end portion 122ff (angle portion and end portion) of the outer layer base material 120 corresponding to the end position of the lead pattern portion At is exposed.

The outer layer base material 120 covering the lead pattern portion At is composed of material that is comparatively fragile and can be peeled away; so breaking off or peeling away of the outer layer base material 120 at the border position BP is possible. Accordingly, by peeling away the outer layer base material 120 from the exposed cutting end portion 122ff, it is possible to remove the outer layer base material 120 that corresponds to the lead pattern portion At.

Also, the border delineating pattern 122cg acts as a guide when peeling the outer layer base material 120, and acts such that the outer layer base material 120 is not peeled away at an unintended portion.

After removing the excess portion of the outer layer base material 120, outer shape processing is performed on the flexible portion and the multilayer portion, and thus the multilayer printed wiring board is completed.

Other than Conventional Example 2, methods of removing outer layer base material of a flexible portion have been proposed. Among these are methods employing half-punching and methods for performing half-groove processing from inside (for example, see JP H5-90756A), methods for cutting from outside during final outer shape processing (for example, see JP H4-34993A), and simple methods in which an adhesive layer is not applied on a flexible portion (for example, see JP H6-216531A, and JP H9-74252A).

Also, methods have been proposed in which, when outer layer base material is comparatively thin, a portion corresponding to the flexible portion is cut out and removed in advance (for example, see JP H6-216537A, JP H18-148835A, and JP 2006-186178A).

Methods have been proposed in which, when outer layer base material is comparatively thick, because of the problem that layering and fastening cannot be performed uniformly due to a difference in the thickness of a flexible portion and a multilayer portion, a member that has been cut out and removed or another member is temporarily returned to a hole where the member was removed, and then the member is removed again after layering, or a mold releasing member is sandwiched, or a material having mold releasing properties is used, or the like (for example, see JP H3-290990A, JP H7-50456A, JP H6-216533A, and JP H6-252552A). Also in the case of a method in which a mold releasing member is sandwiched, much time and effort is required to dispose the mold releasing member at an appropriate position, and it is very difficult to perform control such that the mold releasing member is not displaced during layering, so stable production is difficult.

Further, methods have been proposed such as sandwiching a double-sided mold releasing member or a self-peeling adhesive between the flexible portion and the outer layer base material (for example, see JP H7-135393A).

Also, methods have been proposed in which a multilayer printed wiring board is formed employing self-releasing adhesive tape (for example, see JP 2006-203155A).

As is clear from the above conventional examples, how to remove outer layer base material that is superimposed on a flexible portion, i.e., how to insure that the outer layer base material and the inner layer base material that constitutes the flexible portion are not fastened, is the most important technological point in the manufacturing process for a multilayer printed wiring board of the flex-rigid type.

As disclosed in Conventional Examples 1 and 2, a technique is most widespread in which ordinarily an interlayer adhesive layer is perforated in advance by die processing or the like, corresponding to a flexible portion. Also, it is conceivable that a problem will not occur if the interlayer adhesive layer 125 and the outer layer base material 120 are hole-punched and removed in advance in a region corresponding to the lead pattern portion At (flexible portion); for example, a processing method as shown in FIG. 19 (Conventional Example 3) is also performed.

FIG. 19 is a cross-sectional view that shows an overall state in which an outer layer base material has been layered on an inner layer base material, in a method for manufacturing a multilayer printed wiring board according to Conventional Example 3.

Until layering of the inner layer base material 110 and the coverlay 114, Conventional Example 3 is the same as Conventional Examples 1 and 2. Also, appropriate reference numerals are adopted. In Conventional Example 3, the interlayer adhesive layer 125 and the outer layer base material 120 corresponding to the lead pattern portion At are removed in advance by a method of die processing or router processing. In this example, after establishing a state in which the interlayer adhesive layer 125 and the outer layer base material 120 have been cut out and removed, the interlayer adhesive layer 125 and the outer layer base material 120 (the outer layer insulating base material 121 and the conductor layer 122) have been layered on the inner layer base material 110 and the coverlay 114.

Although there exists this sort of processing method that can be performed simply, many methods have been proposed in which the outer layer base material is left remaining in an intermediate step, and removed in a subsequent step. The reasons for proposing these other methods include, for example, problems (1) to (3) below.

(1) When forming slits or when forming holes in the outer layer base material, incontinuity occurs in the layer thickness (total of layer thickness:total thickness) at the border (border position BP) of the multilayer portion (layered circuit pattern portion Acs/inner layer circuit pattern portion Acf/outer layer circuit pattern portion Ace) and the flexible portion (lead pattern portion At), and therefore when layering and fastening the outer layer base material, layering pressure is unequal, with lower pressure in the flexible portion than in the multilayer portion. Accordingly, there is the problem that interlayer adhesive flows in the direction of the flexible portion where a gap has occurred, the layer thickness of the multilayer portion gradually decreases in the vicinity of the flexible portion (border position BP), unintended fastening occurs in the flexible portion due to squeezing out of the interlayer adhesive, and thus the outer layer base material on the flexible portion cannot be peeled away.

Also, the problem occurs that even if not going so far that the outer layer base material cannot be peeled away, there is a reduction in product quality due to the interlayer adhesive flowing out in the vicinity of the border position BP. Further, an edge of a cut-out portion (hole portion or slit portion) functions as a knife during layering, damaging the flexible portion at the border position of the flexible portion and the multilayer portion, and so a problem occurs that the bending properties of the completed multilayer printed wiring board at the flexible portion, in particular anti-flexibility of the flexible portion at the border position BP, are decreased.

(2) When slits are formed in the outer layer base material in advance and the outer layer base material on the flexible portion is removed in advance, in a desmearing process during formation of one or more through holes or one or more via holes, inner layer base material or an insulating resin layer of the flexible portion in a state exposed via a slit portion or an outer layer removal portion (cut-out portion) is damaged, and thus insulation properties, interlayer adhesive strength, bendability, wear resistance, and the like are markedly reduced.

In order to avoid such a problem, it is necessary to adopt a measure such as forming in advance a metal layer that is tolerant of desmearing (for example, see JP 2003-115665A). Also, damage is incurred not only in a desmearing step, but also in pretreatment (for example, polishing or surface treatment) for each process, so there is the problem that conversely, at the circumference of the border position BP, processing is insufficient due to a height difference.

(3) As is understood from FIG. 19, in a state in which the terminal portion (exposed portion 112tt) in the flexible portion has been exposed, processing is performed in a step after the outer layer base material has been layered, so in each subsequent step it is necessary that the terminal portion is not affected. However, there are the problems that when surface treatment (for example, plating) is being executed on the terminal portion, the terminal portion is peeled away in a subsequent polishing step, or in the case of a copper foil material, the terminal portion is etched during outer layer pattern etching. Thus, in actuality it is necessary to cover the flexible portion, at least the terminal portion, by some method.

Due to the presence of such issues, there is the problem that in reality, the above sort of method can only be used for a multilayer printed wiring board in which no terminal exists in the flexible portion, and a plurality of multilayer portions are linked at the flexible portion (a folding-type multilayer printed wiring board; see FIG. 10).

### SUMMARY OF THE INVENTION

The present invention was made in view of such circumstances, and it is an object thereof to provide a method for manufacturing a multilayer printed wiring board provided with a flexible inner layer base material having an inner layer circuit pattern portion and a lead pattern portion (flexible portion), and an outer layer base material having an outer layer circuit pattern portion layered on the inner layer circuit pattern portion (multilayer portion); in which by affixing a resin film to the lead pattern portion, layering and fastening to the inner layer base material an outer layer adhesive layer disposed corresponding to the inner layer circuit pattern portion and an outer layer conductor layer disposed corresponding to the inner layer base material, and peeling away the resin film from the lead pattern portion after formation of the outer layer circuit pattern, layer unevenness (pressure unevenness) relative to the inner layer base material that accompanies layering treatment of the outer layer adhesive layer and the outer layer conductor layer, and damage to the lead pattern portion that accompanies layering treatment and through hole formation, are suppressed and prevented, thus improving bendabilty of the lead pattern portion, and therefore a multilayer printed wiring board that has high reliability is manufactured.

The method for manufacturing a multilayer printed wiring board according to the present invention is a method for manufacturing a multilayer printed wiring board provided with a flexible inner layer base material having an inner layer circuit pattern portion and a lead pattern portion extended from the inner layer circuit pattern portion, and an outer layer base material having an outer layer circuit pattern portion layered on the inner layer circuit pattern portion; the method being provided with an inner layer pattern formation step of patterning a conductor layer of the inner layer base material to form an inner layer circuit pattern of the inner layer circuit pattern portion and a lead pattern of the lead pattern portion, a resin film affixing step of affixing a resin film to the lead pattern portion, an outer layer base material layering step of layering and fastening to the inner layer base material an outer layer adhesive layer disposed corresponding to the inner layer circuit pattern portion and an outer layer conductor layer disposed corresponding to the inner layer base material, an outer layer pattern formation step of patterning the outer layer conductor layer to form an outer layer circuit pattern portion corresponding to the inner layer circuit pattern portion, and a resin film peeling step of peeling away the resin film from the lead pattern portion.

With this configuration, height difference (incontinuity) at the border position of the outer layer circuit pattern portion and the lead pattern portion, layer unevenness (pressure unevenness) relative to the inner layer base material that accompanies layering treatment of the outer layer adhesive layer and the outer layer conductor layer, and damage to the lead pattern portion that accompanies layering treatment and through hole formation, are suppressed and prevented, thus improving bendability of the lead pattern portion, and therefore it is possible to manufacture a multilayer printed wiring board that has high reliability. Also, in the outer layer base material layering step, the lead pattern portion is in a state in which the resin film and the outer layer conductor layer has been layered, so due to the fluidity of the outer layer adhesive layer corresponding to the inner layer circuit pattern portion, the height difference due to the thickness of the outer layer adhesive layer and the thickness of the resin film is absorbed, thus suppressing incontinuity between the inner layer circuit pattern portion and the lead pattern portion, so it is possible to prevent the occurrence of damage in the lead pattern portion. Also, the outer layer adhesive layer is formed in advance corresponding to the inner layer circuit pattern portion, so it is possible to delineate the border position of the inner layer circuit pattern portion and the lead pattern portion with high precision.

Also, in the method for manufacturing a multilayer printed wiring board according to the present invention, a configuration may be adopted in which an end portion of the resin film is disposed at or to the outside of a border of the lead pattern portion.

With this configuration, it is possible to allow the resin film to function reliably.

Also, in the method for manufacturing a multilayer printed wiring board according to the present invention, a configuration may be adopted in which the resin film is configured with a heat-resistant resin material layer that is tolerant of the application of heat and pressure in the outer layer base material layering step, and a film adhesive layer that is fastened to a face that faces the lead pattern portion of the heat-resistant resin material layer and is tolerant of the application of heat and pressure in the outer layer base material layering step, and is peeled away from the lead pattern portion in the resin film peeling step.

With this configuration, effects on the lead pattern portion in the outer layer base material layering step are suppressed, and thus it is possible to cleanly and precisely configure a high-reliability lead pattern portion.

Also, in the method for manufacturing a multilayer printed wiring board according to the present invention, a configuration may be adopted in which the heat-resistant resin material layer is polyimide resin, and the film adhesive layer is formed with acrylic resin.

With this configuration, it is possible to perform processing of the resin film cleanly, precisely, and with good productivity.

Also, in the method for manufacturing a multilayer printed wiring board according to the present invention, a configuration may be adopted in which the resin film has a thickness of several μm to several tens of μm.

With this configuration, it is possible to suppress a height difference between the inner layer circuit pattern portion and the lead pattern portion, thereby suppressing incontinuity between the inner layer circuit pattern portion and the lead pattern portion.

Also, in the method for manufacturing a multilayer printed wiring board according to the present invention, a configuration may be adopted in which after the resin film affixing step, pretreatment for the outer layer base material layering step is performed.

With this configuration, effects on the lead pattern portion due to the pretreatment of the outer layer base material layering step can be prevented.

Also, in the method for manufacturing a multilayer printed wiring board according to the present invention, a configuration may be adopted in which a through hole formation step of forming one or more through holes for connecting layers is provided between the outer layer base material layering step and the outer layer pattern formation step.

With this configuration, the through hole formation step (through hole process, and via hole process) is executed in a state in which the resin film has been covered by the outer layer conductor layer, so it is possible to prevent effects on the lead pattern portion.

Also, in the method for manufacturing a multilayer printed wiring board according to the present invention, a configuration may be adopted in which the outer layer conductor layer layered on the resin film in the outer layer pattern formation step is removed.

With this configuration, a step of removing the outer layer base material in the lead pattern portion is not necessary, so it is possible to easily peel away the resin film without affecting the lead pattern portion in the resin film peeling step.

With the method for manufacturing a multilayer printed wiring board according to the present invention, a resin film is affixed to the lead pattern portion, an outer layer adhesive layer disposed corresponding to the inner layer circuit pattern portion and an outer layer conductor layer disposed corresponding to the inner layer base material are layered and fastened to the inner layer base material, and the resin film is peeled away from the lead pattern portion after formation of the outer layer circuit pattern, so height difference (incontinuity) at the border position of the outer layer circuit pattern portion and the lead pattern portion, layer unevenness (pressure unevenness) relative to the inner layer base material that accompanies layering treatment of the outer layer adhesive layer and the outer layer conductor layer, and damage to the lead pattern portion that accompanies layering treatment and through hole formation, are suppressed and prevented, thus improving bendability of the lead pattern portion, and obtaining the effect that it is possible to provide a method for manufacturing a multilayer printed wiring board that has high reliability.

### BRIEF DESCRIPTION OF THE DRAWINGS

FIG. 1 is a cross-sectional view that shows the overall configuration of an inner layer base material applied in a method for manufacturing a multilayer printed wiring board according to a first embodiment of the present invention.

FIG. 2 is a cross-sectional view that shows an overall state in which an inner layer circuit pattern portion and a lead pattern portion have been formed in the inner layer base material shown in FIG. 1.

FIG. 3 is a cross-sectional view that shows an overall state in which an insulating protective film has been formed that protects the inner layer base material shown in FIG. 2.

FIG. 4 is a cross-sectional view that shows an overall state in which after covering with a coverlay in FIG. 3, a resin film has been affixed to the lead pattern portion of the inner layer base material.

FIG. 5 is plan view that shows the disposed state, viewed from above (shape viewed from above) of the resin film shown in FIG. 4.

FIG. 6 is a cross-sectional view that shows an overall state in which, after affixing the resin film to the lead pattern portion in FIG. 4, the outer layer base material has been layered and fastened to the inner layer base material.

FIG. 7 is a cross-sectional view that shows an overall state in which after layering and fastening the outer layer base material on the inner layer base material in FIG. 6, a through hole has been formed.

FIG. 8 is a cross-sectional view that shows an overall state in which after forming the through hole in FIG. 7, a through hole conductor has been formed.

FIG. 9 is a cross-sectional view that shows an overall state in which the through hole conductor and an outer layer conductor layer have been patterned to form an outer layer circuit pattern in FIG. 8, and an overall state in which the resin film will be removed.

FIG. 10 is a cross-sectional view that shows an overall state in which the first embodiment is applied to a folding-type multilayer printed wiring board, in a method for manufacturing a multilayer printed wiring board according to a second embodiment of the present invention.

FIG. 11 is a cross-sectional view that shows the overall configuration of an inner layer base material applied in the method for manufacturing a multilayer printed wiring board according to Conventional Example 1.

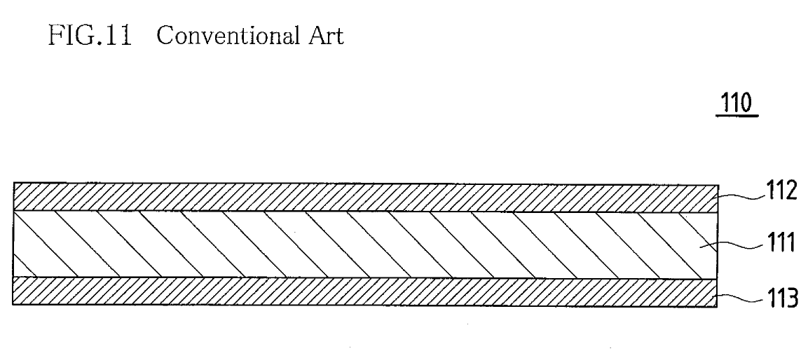

FIG. 12 is a cross-sectional view that shows an overall state in which a resist mask has been formed in order to form the inner layer circuit pattern portion and the lead pattern portion in the inner layer base material shown in FIG. 11.

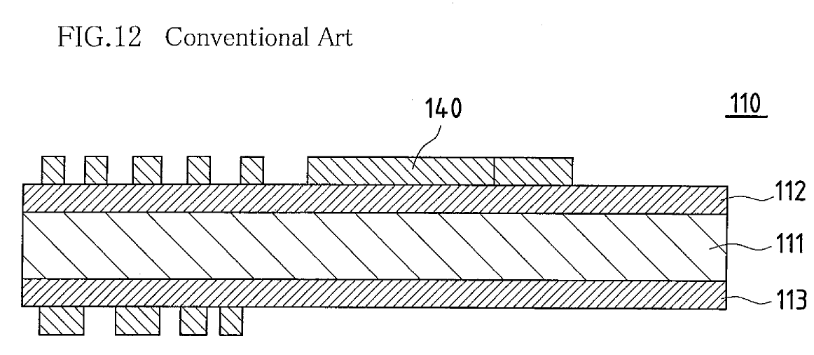

FIG. 13 is a cross-sectional view that shows an overall state in which the inner layer circuit pattern portion and the lead pattern portion have been formed in the inner layer base material, employing the resist mask shown in FIG. 12.

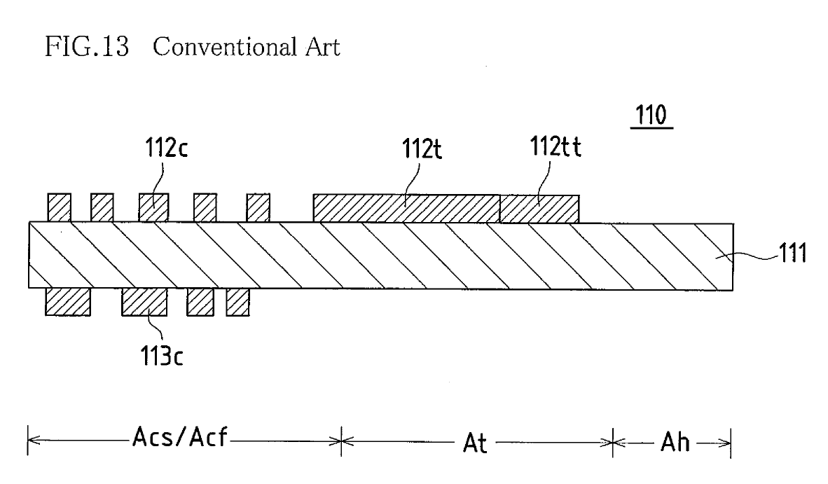

FIG. 14 is a cross-sectional view that shows an overall state in which an insulating protective film has been formed on the inner layer base material shown in FIG. 13.

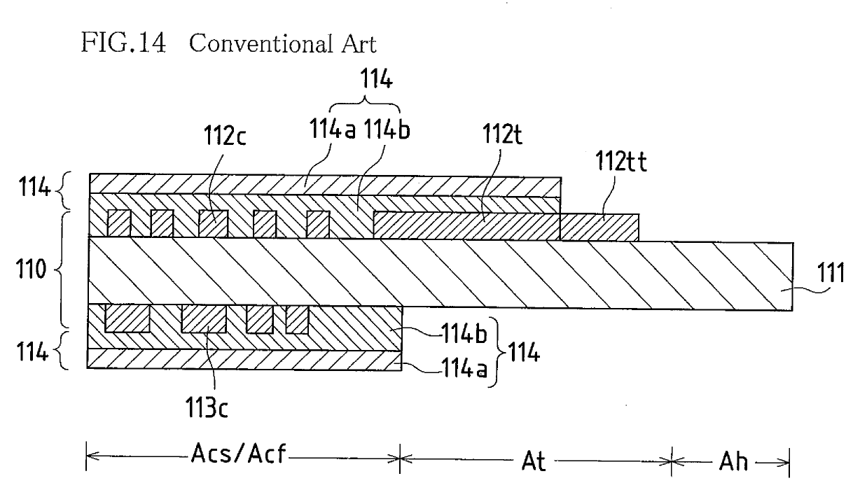

FIG. 15 is a cross-sectional view that shows an overall state in which the outer layer base material has been layered on the inner layer base material shown in FIG. 14.

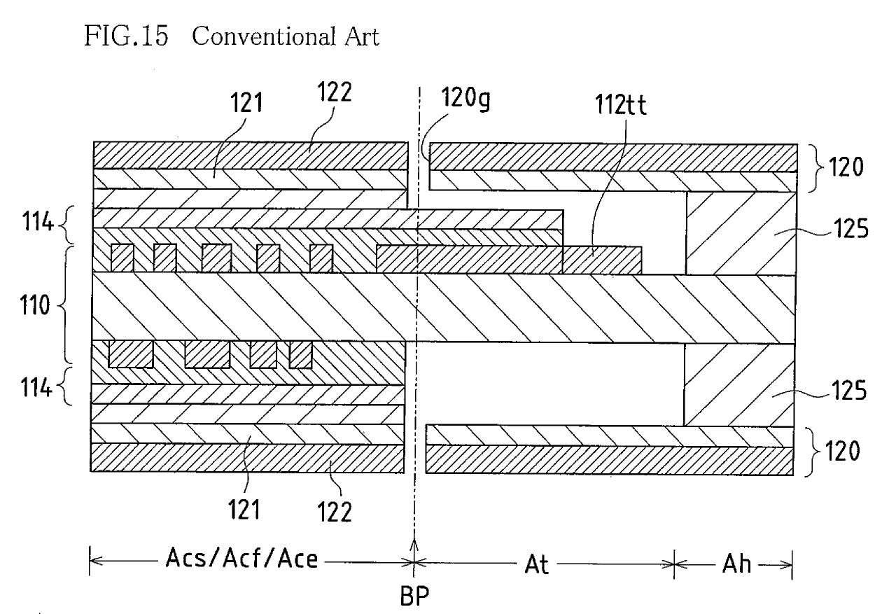

FIG. 16 is a plan view that shows the state in FIG. 15 when viewed from above.

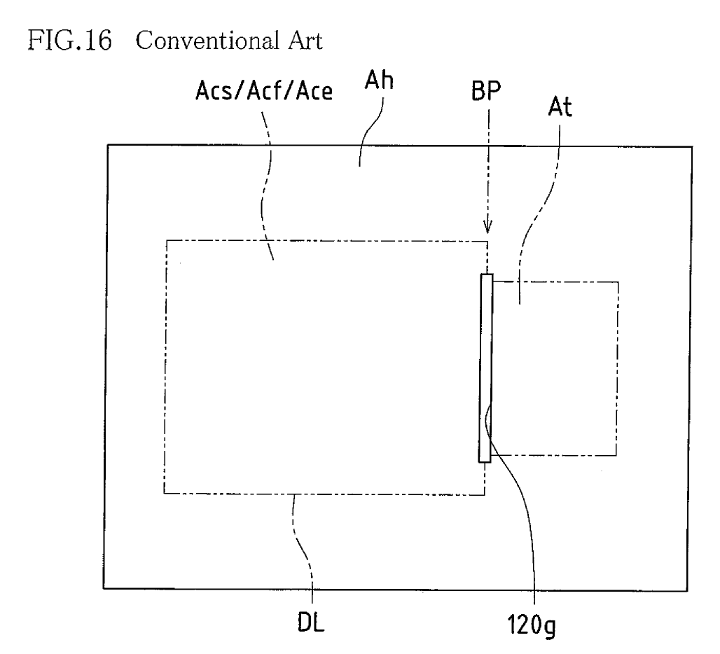

FIG. 17 is a cross-sectional view that shows an overall state in which an outer layer circuit pattern has been formed by layering the outer layer base material on the inner layer base material, in a method for manufacturing a multilayer printed wiring board according to Conventional Example 2.

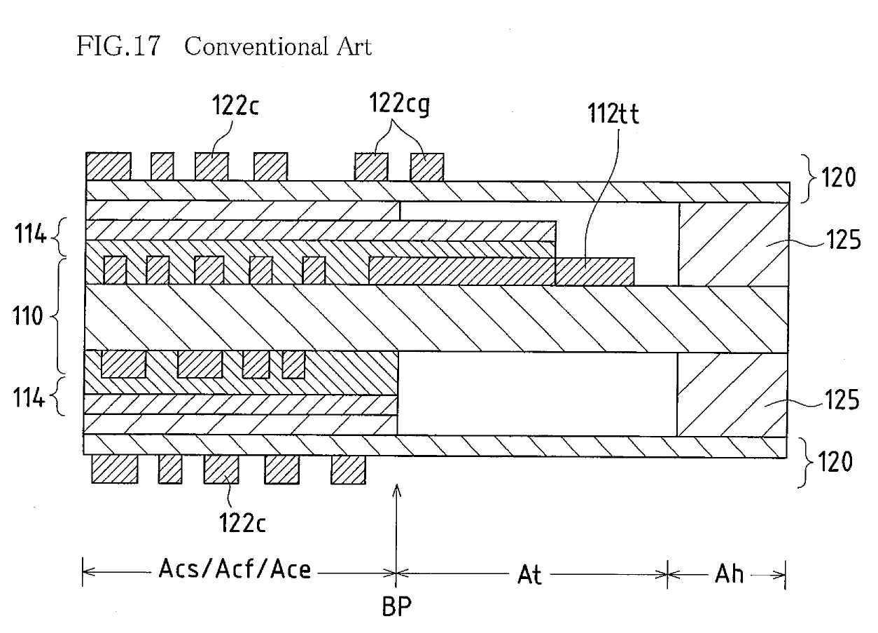

FIG. 18 is a plan view that shows, viewed from above, a state in which a cutting slit has been formed after configuring the outer layer pattern portion in FIG. 17.

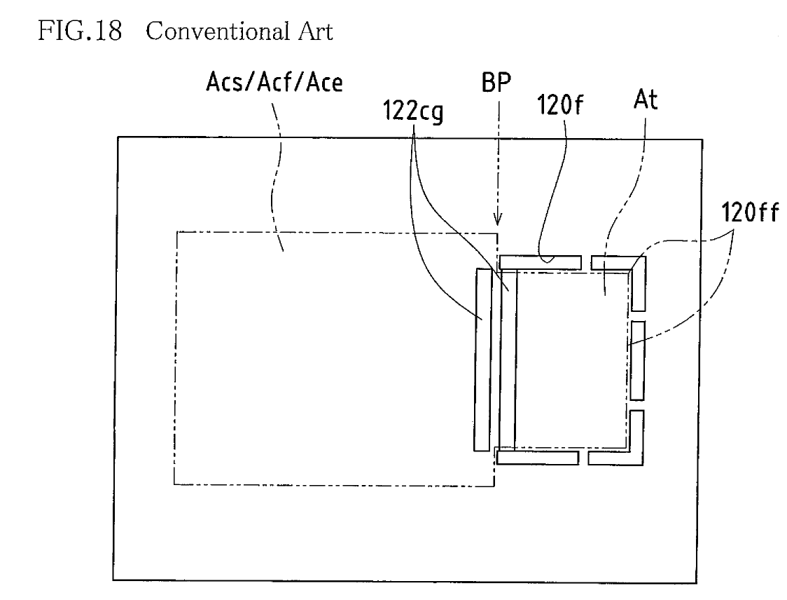

FIG. 19 is a cross-sectional view that shows an overall state in which an outer layer base material has been layered on an inner layer base material, in a method for manufacturing a multilayer printed wiring board according to Conventional Example 3.

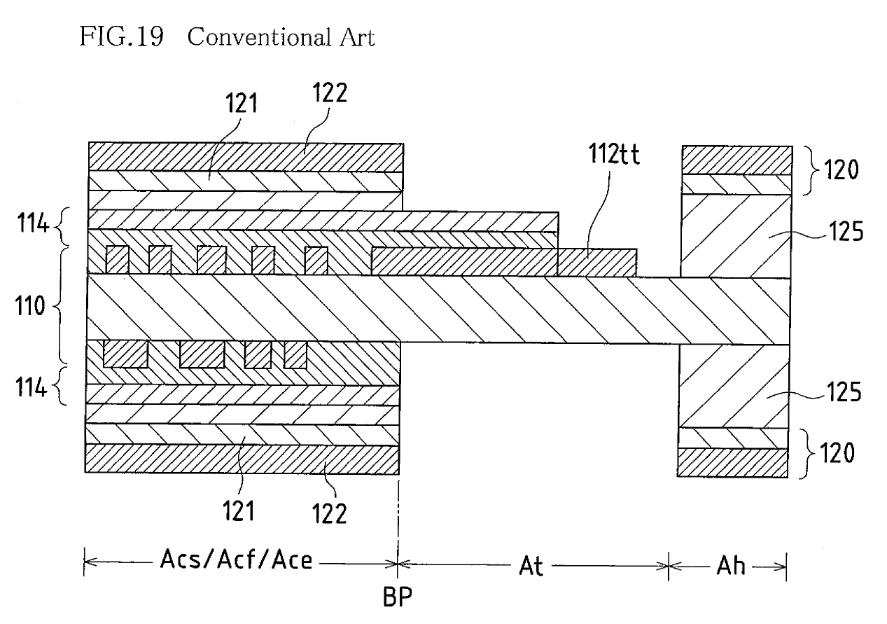

### DESCRIPTION OF THE PREFERRED EMBODIMENTS

Hereinafter, embodiments of the present invention will be described in detail with reference to the accompanying drawings. In order to simplify the description of the following embodiments, an example multilayer printed wiring board is disclosed with a configuration in which a flexible portion (a lead pattern portion) is a single-layer conductor layer, and a multilayer portion (a layered circuit pattern portion) is a four-layer conductor layer, but the layered circuit pattern portion is not limited to being a four-layer conductor layer, and may be a three-layer conductor layer, or may have another multilayer configuration. Also, the following configurations are applicable in any form of multilayer printed wiring board, including a so-called built-up substrate according to a laser method, photo-via method, or the like.

### First Embodiment

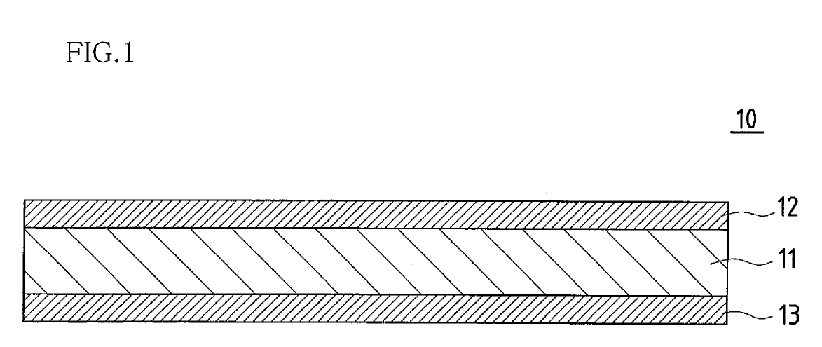

Following is a description of a method for manufacturing a multilayer printed wiring board according to a first embodiment, with reference to FIGS. 1 to 9.

In the first embodiment is described, as an example, a multilayer printed wiring board (a so-called flying tail-type) with a form in which a flexible lead pattern portion is extended from approximately the middle in the thickness direction of the layered circuit pattern portion where an inner layer circuit pattern portion and an outer layer circuit pattern portion have been layered.

FIG. 1 is a cross-sectional view that shows the overall configuration of an inner layer base material applied in a method for manufacturing a multilayer printed wiring board according to a first embodiment of the present invention.

An inner layer base material 10 is configured with a flexible inner layer insulating base material 11 that serves as an inner layer core, and conductor layers 12 and 13 formed on both faces of the inner layer insulating base material 11. The inner layer insulating base material 11, for example, is an insulating resin film such as a polyimide, polyether ketone, or crystal polymer. Also, the conductor layers 12 and 13 are obtained by layering, for example, a conductor metal (metal layer) such as copper foil on the surface of the inner layer insulating base material 11, with interposition of adhesive or without adhesive.

A double-sided flexible multilayer printed wiring board material that is ordinarily commercially available can be employed as the inner layer base material 10. In the first embodiment, for example, the material used has copper foil with a thickness of 12.5 μm to 25 μm layered and fastened to both faces of a polyimide film having a thickness of 25 μm. Accordingly, the inner layer base material 10 is configured to have flexibility as a whole. Also, the material and/or the thickness of the inner layer base material 10 can be appropriately selected according to the specifications required by the flexible portion (lead pattern portion).

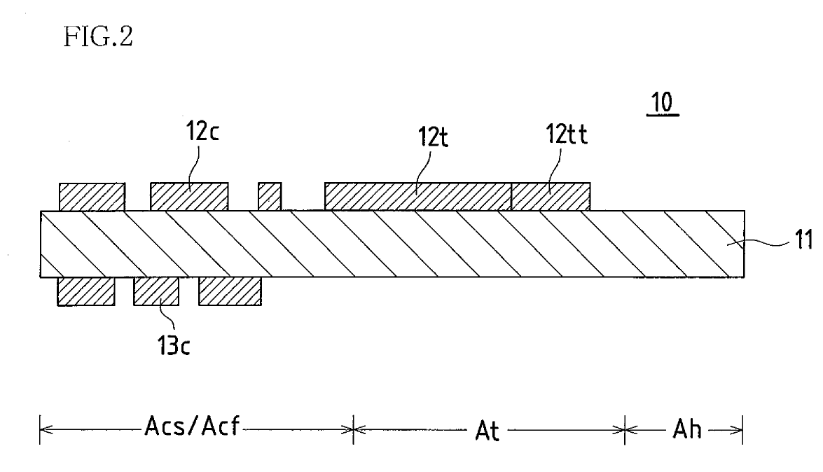

FIG. 2 is a cross-sectional view that shows an overall state in which an inner layer circuit pattern portion and a lead pattern portion have been formed in the inner layer base material shown in FIG. 1.

An etching resist is formed on the surface of the conductor layers 12 and 13 by employing a commonly-known circuit pattern formation method (such as a photolithography method), and by etching (patterning) the conductor layers 12 and 13 with an appropriate etching fluid (for example, such as cupric chloride or ferrous chloride), an inner layer circuit pattern 12c, an inner layer circuit pattern 13c, and a lead pattern 12t are formed.

The inner layer circuit pattern 12c and the inner layer circuit pattern 13c constitute an inner layer circuit pattern portion Acf. The lead pattern 12t constitutes a lead pattern portion At extended from the inner layer circuit pattern portion Acf. That is, by patterning the conductor layers 12 and 13 of the inner layer base material 10, the inner layer circuit pattern portion Acf (inner layer circuit patterns 12c and 13c) and the lead pattern portion At (lead pattern 12t) are formed (inner layer pattern formation step).

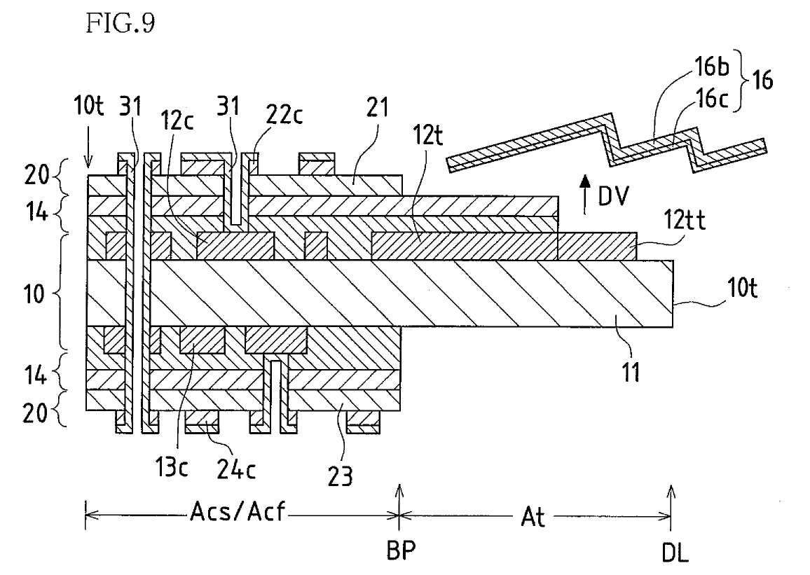

The inner layer circuit pattern portion Acf has a two-layer structure configured with the inner layer circuit patterns 12c and 13c, but may also be configured with a single layer of only the inner layer circuit pattern 12c. Also, in the inner layer circuit pattern portion Acf, outer layer circuit patterns 22c and 24c are formed by layering in a subsequent step, thus configuring a layered circuit pattern portion Acs/outer layer circuit pattern portion Ace (see FIG. 9).

The lead pattern 12t is a lead pattern for making an external connection, and is extended from the inner layer circuit pattern 12c (the inner layer circuit pattern portion Acf). Formed at the tip of the lead pattern 12t is an exposed portion 12tt that acts as a terminal portion/land portion. Also, surface treatment such as gold plating or the like is performed on the exposed portion 12tt in a subsequent step, so that the exposed portion 12tt functions as a connection terminal that is connected to outside. That is, the exposed portion 12tt is a portion drawn out as a connection terminal of the lead pattern portion At of the completed multilayer printed wiring board.

In the first embodiment, the lead pattern portion At is configured having only a single layer of the lead pattern 12t, so the lead pattern extended from the inner layer circuit pattern 13c is not formed.

Also, when one or more inner via holes that connect the inner layer circuit pattern 12c and the inner layer circuit pattern 13c (or the outer layer circuit patterns 22c and 24c described below) to each other are necessary, in the same manner as a conventional method, it is possible to appropriately perform through hole processing, hole filling processing if necessary, or the like.

A discarded plate portion Ah that is ultimately cut away is disposed around the circumference of the inner layer circuit pattern portion Acf (layered circuit pattern portion Acs) and the lead pattern portion At.

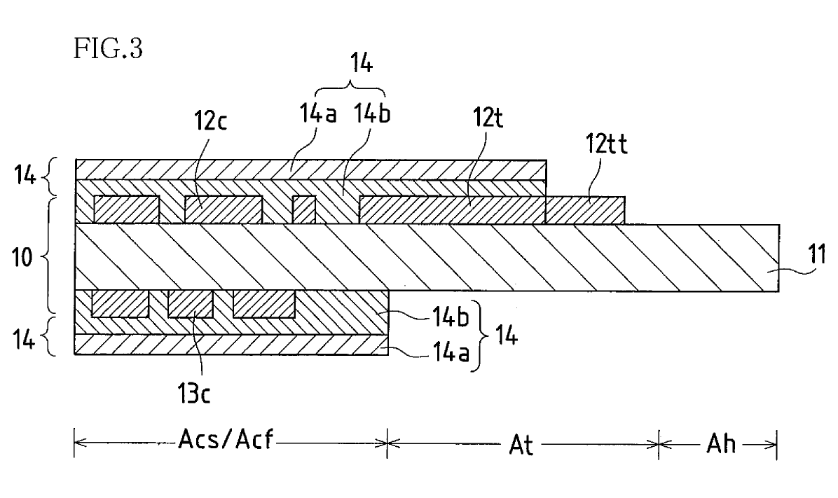

FIG. 3 is a cross-sectional view that shows an overall state in which an insulating protective film has been formed that protects the inner layer base material shown in FIG. 2.

After the inner layer pattern formation step, a coverlay 14 that serves as an insulating protective film is fastened to conductor layer portions other than the exposed portion 12tt (the inner layer circuit pattern 12c, the inner layer circuit pattern 13c, and the lead pattern 12t). It is desirable to employ the same material as the insulating resin film of the inner layer insulating base material 11, with approximately the same thickness, as the coverlay 14.

In the first embodiment, for example, a commercially available coverlay material is used that has a coverlay base material 14a that is a polyimide film with a thickness of 25 μm, same as the inner layer insulating base material 11, and a coverlay adhesive layer 14b formed on one side of the coverlay base material 14a. As described above, the exposed portion 12tt is not covered by the coverlay 14, so that the conductor layer is left exposed.

The coverlay 14 is affixed to the entire surface except for the terminal area (exposed portion 12tt) of the lead pattern portion At, including the inner layer circuit pattern portion Acf. However, a method is also possible in which, with the object of reducing the total thickness of the layered circuit pattern portion Acs, improving the interlayer adhesive properties of the layered circuit pattern portion Acs, and the like, the coverlay 14 is not provided on the layered circuit pattern portion Acs. Also, with the object of increasing reliability of through hole formation between layers, a configuration is also possible in which the coverlay 14 is excluded from the area around a through hole.

Next, surface treatment is performed on the exposed portion 12tt, such as gold plating, tin plating, rust-proofing treatment, or the like. For example, when performing gold plating, after performing polishing or soft etching of the surface of the conductor layer, applying a plating resist to a portion where plating is not necessary, and performing pretreatment such as seeding, nickel plating and gold plating are performed in order.

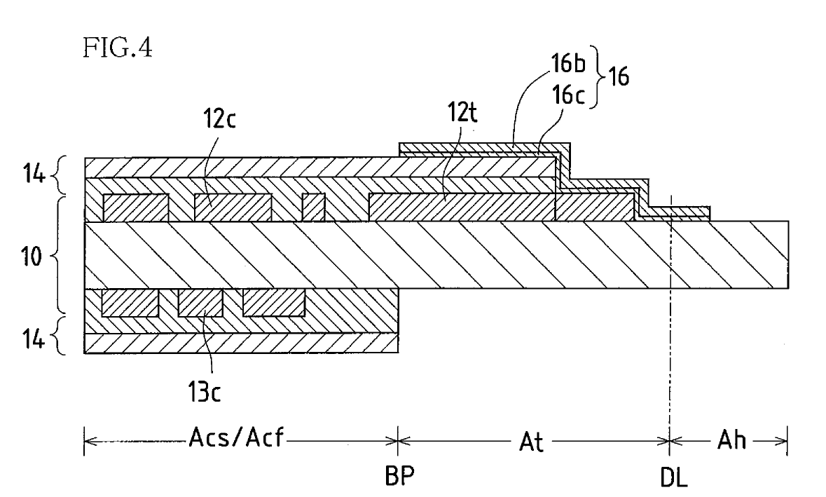

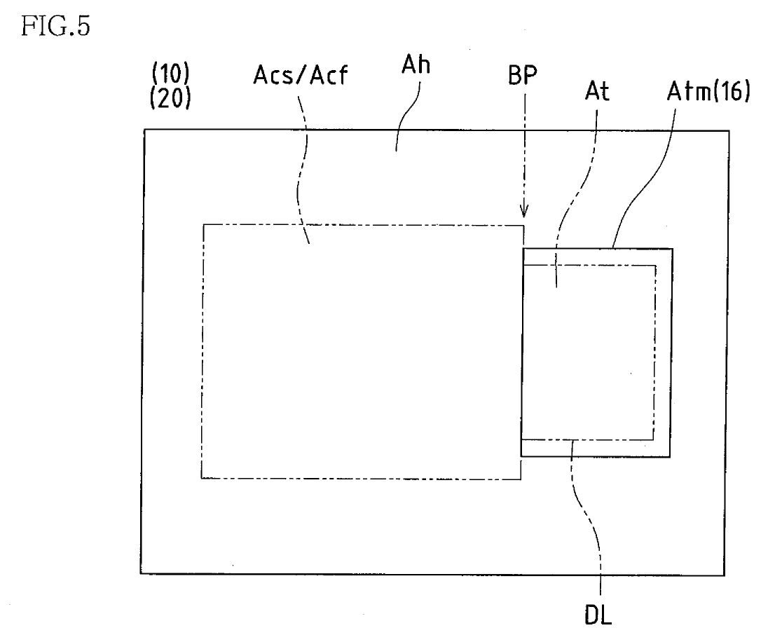

FIG. 4 is a cross-sectional view that shows an overall state in which after covering with a coverlay in FIG. 3, a resin film has been affixed to the lead pattern portion of the inner layer base material. FIG. 5 is plan view that shows the disposed state, viewed from above (shape viewed from above) of the resin film shown in FIG. 4. In FIG. 5, for the sake of a more legible drawing, circuit patterns, resists, holes, and the like are not shown.

A resin film 16 is affixed to the lead pattern portion At (resin film affixing step).

An end portion of the resin film 16 (end portion in the shape viewed from above) is disposed at a border of the lead pattern portion At (for example, the border with the inner layer circuit pattern portion Acf is indicated by a border position BP), or outside of the border (for example, the discarded plate portion Ah that is outside from a cutting line DL that delineates the outer shape), thus covering the entire face where the lead pattern 12t of the lead pattern portion At has been formed. With this configuration, the resin film 16 is caused to function reliably, and thus it is possible to reliably protect the lead pattern portion At.

The shape of the resin film 16 viewed from above is delineated in consideration of end finishing of each region (the lead pattern portion At, the inner layer circuit pattern portion Acf, and the layered circuit pattern portion Acs), processability, and the like.

That is, at the border (the border position BP) of the lead pattern portion At and the inner layer circuit pattern portion Acf (the layered circuit pattern portion Acs), the end portion of the resin film 16 is disposed matching the border position BP, or extended from the border position BP not more than, for example, several mm to the side of the inner layer circuit pattern portion Acf.

Also, in consideration of an allowable error or the like of a die during outer shape formation relative to the region other than the border position BP (discarded plate portion Ah), a configuration is adopted with an excess outer shape Atm that is somewhat larger than the cutting line DL (which configures the outer shape of the lead pattern portion At when the multilayer printed wiring board is completed), for example about several mm larger. Note that below, reference is made to simply the lead pattern portion At, without distinguishing between the lead pattern portion At and the excess outer shape Atm.

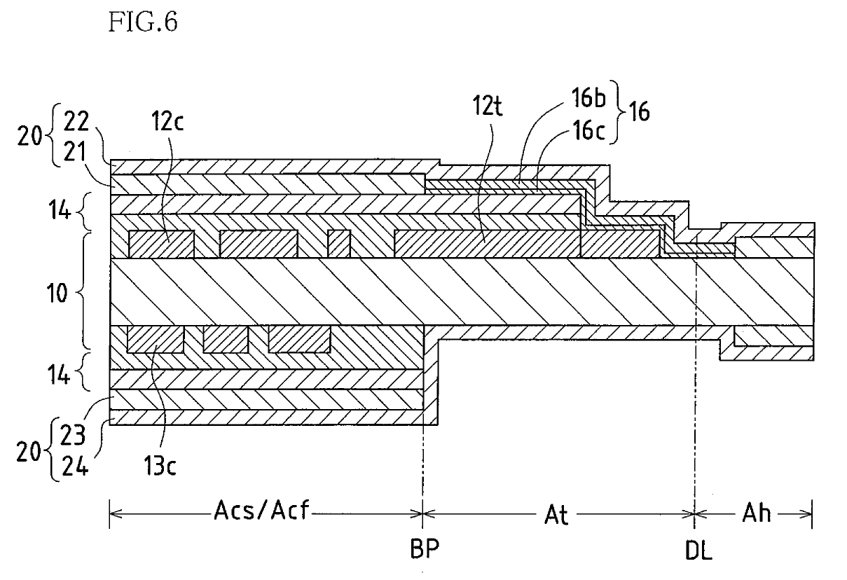

The resin film 16 is configured with a heat-resistant resin material layer 16b that is tolerant of the application of heat and pressure in an outer layer base material layering step (see FIG. 6) described below, and a film adhesive layer 16c that is fastened to a face that faces the lead pattern portion At of the heat-resistant resin material layer 16b and is tolerant of the application of heat and pressure in the outer layer base material layering step, and is easily and cleanly peeled away from the lead pattern portion At in a resin film peeling step (see FIG. 9) described below. With this configuration, effects on the lead pattern portion At in the outer layer base material layering step are suppressed, and thus it is possible to configure a high-reliability lead pattern portion At cleanly and with high precision.

Also, the resin film 16 is required to not only be tolerant of heat and pressure, but also to have physical properties such that there is no harmful gas discharge or occurrence of exudation. Also, the resin film 16 is required to have a physical property of tolerating pretreatment for the outer layer base material layering step.

In the first embodiment, the heat-resistant resin material layer 16b is formed with polyimide resin, and the film adhesive layer 16c is formed with acrylic resin. With this configuration, it is possible to perform processing of the resin film 16 cleanly, precisely, and with good productivity. Also, it is possible for the resin film 16 to have high reliability.

The resin film 16 has a thickness of, for example, several μm to several tens of μm. With this configuration, it is possible to suppress a height difference between the inner layer circuit pattern portion Acf and the lead pattern portion At, thereby suppressing incontinuity between the inner layer circuit pattern portion Acf and the lead pattern portion At.

Also, it is possible to employ, for example, a non-silicone heat-resistant masking tape as the resin film 16 having the above properties.

In the first embodiment, the lead pattern 12t of the lead pattern portion At is configured as a one-sided pattern, and a lead pattern 12t is not formed on the back face of the inner layer insulating base material 11. Accordingly, the resin film 16 is not affixed to the back face of the inner layer insulating base material 11. When a lead pattern 12t is also formed on the back face of the inner layer insulating base material 11 so that the lead pattern portion At has a two-sided pattern, it is possible to likewise form a resin film 16 on the back face.

FIG. 6 is a cross-sectional view that shows an overall state in which, after affixing the resin film to the lead pattern portion in FIG. 4, the outer layer base material has been layered and fastened to the inner layer base material.

After the resin film affixing step, outer layer adhesive layers 21 and 23 and outer layer conductor layers 22 and 24 are prepared that constitute the outer layer base material 20 and are layered on both sides faces of the inner layer base material 10. In the first embodiment, a semi-hardened epoxy resin sheet is employed as the outer layer adhesive layers 21 and 23, and copper foil having a thickness of 18 μm is employed as the outer layer conductor layers 22 and 24. As described below, the outer layer adhesive layers 21 and 23 absorb a height difference, so it is preferable that the resin film 16 is thinner than the outer layer adhesive layers 21 and 23.

First, a region that corresponds to the excess outer shape Atm (see FIG. 5) as a region that corresponds to the lead pattern portion At is cut out and removed from the semi-hardened epoxy resin sheet (a cut out removal step), and thus the outer layer adhesive layers 21 and 23 are prepared with a shape that corresponds to the inner layer circuit pattern portion Acf.

The shape of the region that has been cut out may be basically the same as the lead pattern portion At, but as described above, the shape is made the same as the excess outer shape Atm, in consideration of processability, end face finishing, and the like in subsequent steps. That is, the excess outer shape Atm has a shape expanded to the outside of the outer shape of the lead pattern portion At. Also, the outer layer conductor layers 22 and 24 are prepared with a shape that corresponds to the inner layer base material 10.

Together with preparation of the outer layer adhesive layers 21 and 23 and the outer layer conductor layers 22 and 24, after the resin film affixing step, pretreatment (not shown) for the outer layer base material layering step is performed. Because the lead pattern portion At (lead pattern 12t) is covered by the resin film 16, it is possible to prevent effects on the lead pattern portion due to pretreatment of the outer layer base material layering step.

That is, as pretreatment for the outer layer base material layering step, washing, polishing, roughening with a chemical agent, hydrophilic treatment, plasma treatment, or the like are ordinarily performed on the inner layer base material 10, and by performing these pretreatments after the resin film affixing step, it is possible to reliably protect the surface of the lead pattern portion At.

After performing the pretreatment for the outer layer base material layering step, the outer layer adhesive layers 21 and 23 disposed corresponding to the inner layer circuit pattern portion Acf and the outer layer conductor layers 22 and 24 disposed corresponding to the inner layer base material 10 are layered and fastened to the inner layer base material 10 (outer layer base material layering step). That is, the outer layer base material 20 is layered and fastened to both faces of the inner layer base material 10.

In the outer layer base material layering step, a height difference (incontinuity) at the border position BP of the lead pattern portion At and the inner layer circuit pattern portion Acf is unlikely to occur, because the height difference is prescribed by the thickness of the resin film 16. Further, unevenness of the surface of the outer layer conductor layers 22 and 24 is also limited.

More specifically, at the face where the lead pattern 12t has been formed, the difference in the thickness of the lead pattern portion At and the base material (the inner layer base material 10, the outer layer base material 20, and the resin film 16) of the inner layer circuit pattern portion Acf (layered circuit pattern portion Acs) only corresponds to one sheet of the resin film 16. That is, it is possible to suppress the difference in thickness to a maximum of approximately not more than several μm to several tens of μm.

In the outer layer base material layering step, also the height difference due to the thickness of the resin film 16 is absorbed by the outer layer adhesive layer 21, so a state is established in which the height difference is not so great as to harm the lead pattern portion At.

The resin film 16 is in a state closely fitted to the lead pattern portion At, so a gap as in the conventional examples does not occur, and damage to the lead pattern portion At due to squeezing out of the outer layer adhesive layer 21 does not occur.

Also, the lead pattern portion At is in a state protected by being covered by the layer structure of the resin film 16 and the outer layer conductor layer 22, so it is possible to greatly suppress effects on the lead pattern portion At due to processing.

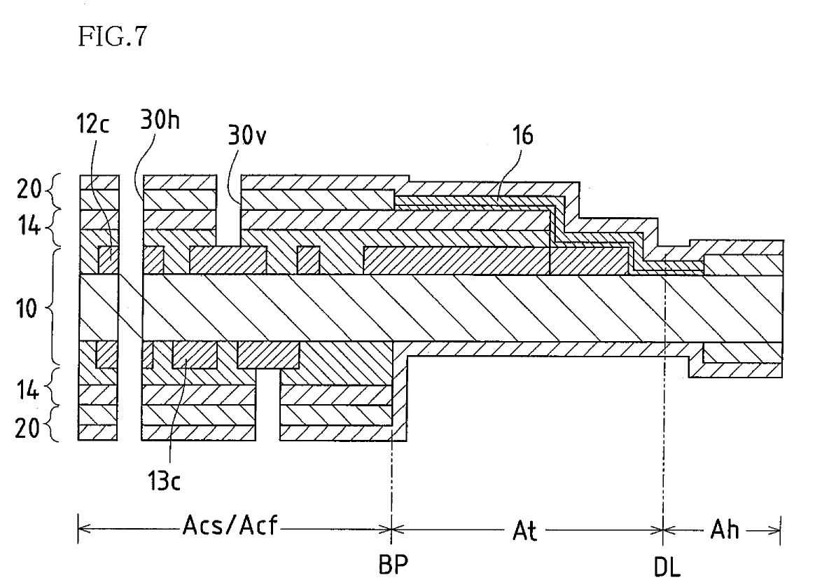

As described above, according to the first embodiment, layer unevenness (pressure unevenness) relative to the inner layer base material 10 that accompanies layering treatment of the outer layer adhesive layers 21 and 23 and the outer layer conductor layers 22 and 24, and damage to the lead pattern portion At that accompanies layering treatment and through hole formation described below (see FIG. 7), are suppressed and prevented, thus improving bendability of the lead pattern portion At, and therefore it is possible to manufacture a multilayer printed wiring board that has high reliability.

Also, in the outer layer base material layering step, the lead pattern portion At is in a state in which the resin film 16 and the outer layer conductor layers 22 and 24 have been layered, so due to the fluidity of the outer layer adhesive layers 21 and 23 corresponding to the inner layer circuit pattern portion Acf, the height difference due to the thickness of the outer layer adhesive layers 21 and 23 and the thickness of the resin film 16 is absorbed, thus suppressing incontinuity between the inner layer circuit pattern portion Acf and the lead pattern portion At, so it is possible to prevent the occurrence of damage in the lead pattern portion At.

Also, the outer layer adhesive layers 21 and 23 are formed in advance corresponding to the inner layer circuit pattern portion Acf, so it is possible to delineate the border position BP of the inner layer circuit pattern portion Acf and the lead pattern portion At with high precision.

FIG. 7 is a cross-sectional view that shows an overall state in which after layering and fastening the outer layer base material on the inner layer base material in FIG. 6, a through hole has been formed.

After layering of the outer layer base material 20 on the inner layer base material 10 is finished, one or more through holes are formed with the same procedure as in the conventional examples. That is, one or more via holes 30v or one or more through holes 30h are formed (through hole formation step).

That is, the through hole formation step of forming one or more through holes is provided for connecting layers, between the outer layer base material layering step described above and an outer layer pattern formation step described below. With this configuration, the through hole formation step (through hole process, and via hole process) is executed in a state in which the resin film has been covered by the outer layer conductor layer, so it is possible to prevent effects on the lead pattern portion due to the through hole formation step.

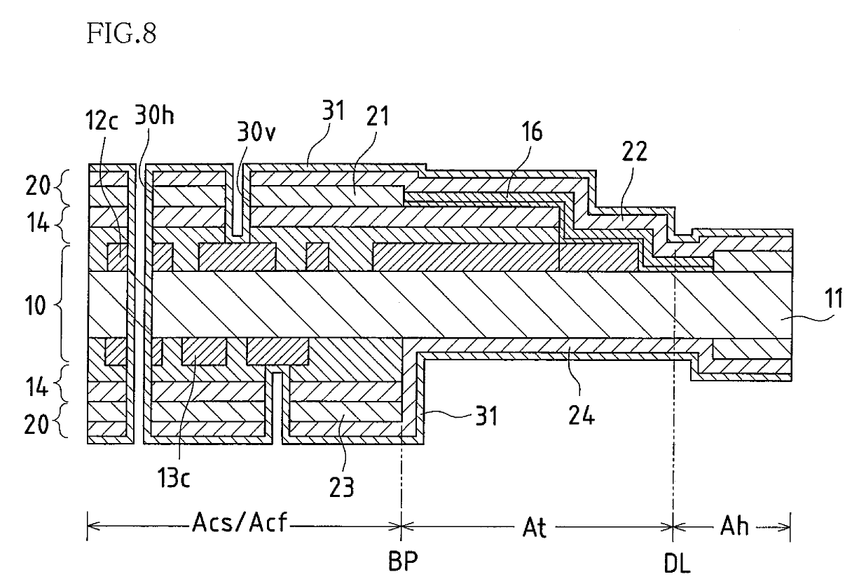

Plating pretreatment (a plating pretreatment step) is performed prior to forming a through hole conductor 31 (see FIG. 8) in order to make an interlayer connection via the through hole (via hole 30v or through hole 30h). As plating pretreatment, for example, surface polishing or a desmearing process is ordinarily performed.

Plating pretreatment such as desmearing is a step of removing resin staining/oil staining caused by an insulating base material (synthetic resin) or the like that constitutes the inner layer base material/outer layer base material, using a strong alkali, plasma, or the like, and in a method such as that introduced in the conventional examples (a method in which one or more holes are formed in advance in the outer layer base material of the lead pattern portion), the surface of the lead pattern portion is exposed, so there may be a circumstance in which a region exposed to the surface of the coverlay constituted of synthetic resin, the terminal portion, or the like is infringed upon, resulting in a dramatic reduction in properties or defects in external appearance.

In the first embodiment, the affixed resin film 16 and the coverlay 14 are not formed on the lead pattern portion At, so there is a risk that this sort of phenomenon will likewise occur for the back face of the inner layer base material 10 where the inner layer insulating base material 11 is exposed.

However, in the plating pretreatment step, the resin film 16 is covered by the outer layer conductor layer 22. Also, the inner layer insulating base material 11 is covered by the outer layer conductor layer 24. Accordingly, because the surface of the resin film 16 and the inner layer insulating base material 11 is covered by the outer layer conductor layers 22 and 24, it is possible to avoid effects due to plating pretreatment such as desmearing.

More specifically, the outer layer conductor layers 22 and 24 are configured with copper foil or the like that is the conductor layer that constitutes the outer layer circuit patterns 22c and 24c (see FIG. 9), so the outer layer conductor layers 22 and 24 are not harmed by desmearing treatment. Accordingly, it is possible to completely protect the lead pattern portion At (the lead pattern 12t and the inner layer insulating base material 11) disposed to the inside of the inner layer.

Also, in oxidation removal treatment, coarsening treatment, or polishing treatment of the surface of the outer layer conductor layers 22 and 24 in order to improve close-fitting strength of the through hole conductor (through hole plating metal) 31, there is not a height difference that occurs when first forming one or more holes in the outer layer base material as in the conventional examples, rather, it is possible to effectively perform treatment all the way to the corner, and the surface of the lead pattern portion At is not damaged, so it is not necessary to self-suppress the degree of treatment in consideration of the state of the surface of the lead pattern portion At, and therefore it is possible to adequately perform as much of the necessary treatment as is necessary.

FIG. 8 is a cross-sectional view that shows an overall state in which after forming the through hole in FIG. 7, a through hole conductor has been formed.

After the plating pretreatment step of desmearing, polishing, or the like, through hole plating is performed, thus forming the through hole conductor 31 (through hole conductor formation step). After the through hole plating, necessary post-treatment is performed, and the method proceeds to the outer layer pattern formation step (see FIG. 9).

FIG. 9 is a cross-sectional view that shows an overall state in which the through hole conductor and an outer layer conductor layer have been patterned to form an outer layer circuit pattern in FIG. 8, and an overall state in which the resin film will be removed.

After the through hole conductor formation step, the outer layer conductor layers 22 and 24 (and the through hole conductor 31; reference to the through hole conductor 31 may be omitted below) are patterned to form outer layer circuit patterns 22c and 24c, thus forming the outer layer circuit pattern portion Ace that corresponds to the inner layer circuit pattern portion Acf (outer layer pattern formation step). By formation of the outer layer circuit pattern portion Ace with the outer layer base material 20, the layered circuit pattern portion Acs, in which the inner layer circuit pattern portion Acf and the outer layer circuit pattern portion Ace have been layered, is completed.

The outer layer pattern formation step can be performed by employing commonly known technology. For example, the outer layer pattern formation step can be performed by a method in which processing is performed that involves formation of a photosensitive etching resist (photomask), and etching of the outer layer conductor layers 22 and 24 with an etchant (etching step).

Also, in the outer layer pattern formation step, the outer layer conductor layer 22 layered on the resin film 16 is also removed (etched). With this configuration, the outer layer base material 20 (the outer layer adhesive layer 21, and the outer layer conductor layer 22) is not present on the surface of the resin film 16, and so removal of the outer layer base material in the lead pattern portion At (outer layer base material removal step) that was a problem in the conventional examples is unnecessary. Thus, it is possible to easily peel away the resin film 16 without affecting the lead pattern portion At in a resin film peeling step described below. Also, the outer layer conductor layer 24 layered on the back face of the inner layer insulating base material 11 is likewise removed.

More specifically, a configuration is adopted in which in the resin film affixing step, the resin film 16 is affixed to the surface of the lead pattern portion At, and moreover the outer layer conductor layer 22 has been layered, but in the etching step, the outer layer conductor layer 22 is completely removed by etching. Due to the etching step, a state emerges in which the resin film 16 remains corresponding to the lead pattern portion At, but basically there is no outer layer base material 20. Accordingly, the work of removing the outer layer base material that was a problem in conventional methods can be made unnecessary.

After the outer layer pattern formation step, appropriate treatment is performed, such as solder resist treatment, silk printing treatment, or surface treatment such as plating or rust-proofing. These treatment methods can be performed employing conventionally known technology, so a description thereof is omitted here.

Then, outer shape processing is performed (outer shape processing step). The outer shape processing step is divided into two stages. That is, outer shape processing includes a so-called outer shape cutting process (outer shape cutting step) for establishing the shape (outer shape) of the multilayer printed wiring board in an actually completed state, and a step of removing, by peeling away, the resin film 16 that has been affixed to the surface of the lead pattern portion At (resin film peeling step).

FIG. 9 shows a state in which the resin film 16 has been peeled away in the direction of arrow DV, after formation of the outer circumferential edge (outer shape) 10t by performing the outer shape cutting process at the cutting line DL. As for the processing order, either the outer shape cutting step or the resin film peeling step may be performed first, so it is good to adopt a procedure with which work is easily performed.

In comparison to the work in the conventional examples, in which the outer shape process is divided into two instances, and the outer layer base material that has been superimposed on the lead pattern portion At is peeled away, the resin film peeling step of peeling away the resin film 16, in which there is no change in properties due to application of heat and pressure in the outer layer layering step, is a very simple step, and the peeling strength (the force necessary for peeling away the resin film 16) is low, so there is little occurrence of deforming the inner layer base material 10, particularly the lead pattern portion At, when peeling away the resin film 16, or causing damage when starting to peel away the resin film 16, or applying excessive stress to the border position BP of the lead pattern portion At and the inner layer circuit pattern portion Acf when peeling away the resin film 16.

Accordingly, there is only a very low possibility of reducing the bendability property of the lead pattern portion At (flexible portion), or that cracking will occur. Also, because finishing is clean at the end portion of the layered circuit pattern portion Acs at the border (border position BP) of the layered circuit pattern portion Acs (multilayer portion) and the lead pattern portion At, it is moreover possible to improve the bendability property.

As described above, the method for manufacturing a multilayer printed wiring board according to the first embodiment is a method for manufacturing a multilayer printed wiring board provided with a flexible inner layer base material 10 having an inner layer circuit pattern portion Acf and a lead pattern portion At extended from the inner layer circuit pattern portion Acf, and an outer layer base material 20 having an outer layer circuit pattern portion Ace layered on the inner layer circuit pattern portion Acf; the method being provided with an inner layer pattern formation step, a resin film affixing step, an outer layer base material layering step, an outer layer pattern formation step, and a resin film peeling step.

With this configuration, height difference (incontinuity) at the border position BP of the outer layer circuit pattern portion Ace and the lead pattern portion At, layer unevenness (pressure unevenness) relative to the inner layer base material 10 that accompanies layering treatment of the outer layer adhesive layers 21 and 23 and the outer layer conductor layers 22 and 24, and damage to the lead pattern portion At that accompanies layering treatment and through hole formation, are suppressed and prevented, thus improving bendability of the lead pattern portion At, and therefore it is possible to manufacture a multilayer printed wiring board that has high reliability. Also, in the outer layer base material layering step, the lead pattern portion At is in a state in which the resin film 16 and the outer layer conductor layer 22 has been layered, so due to the fluidity of the outer layer adhesive layer 21 corresponding to the inner layer circuit pattern portion Acf, the height difference due to the thickness of the outer layer adhesive layer 21 and the thickness of the resin film 16 is absorbed, thus suppressing incontinuity between the inner layer circuit pattern portion Acf and the lead pattern portion At, so it is possible to prevent the occurrence of damage in the lead pattern portion At. Also, the outer layer adhesive layers 21 and 23 are formed in advance corresponding to the inner layer circuit pattern portion Acf, so it is possible to delineate the border position of the inner layer circuit pattern portion Acf and the lead pattern portion At with high precision.

### Second Embodiment

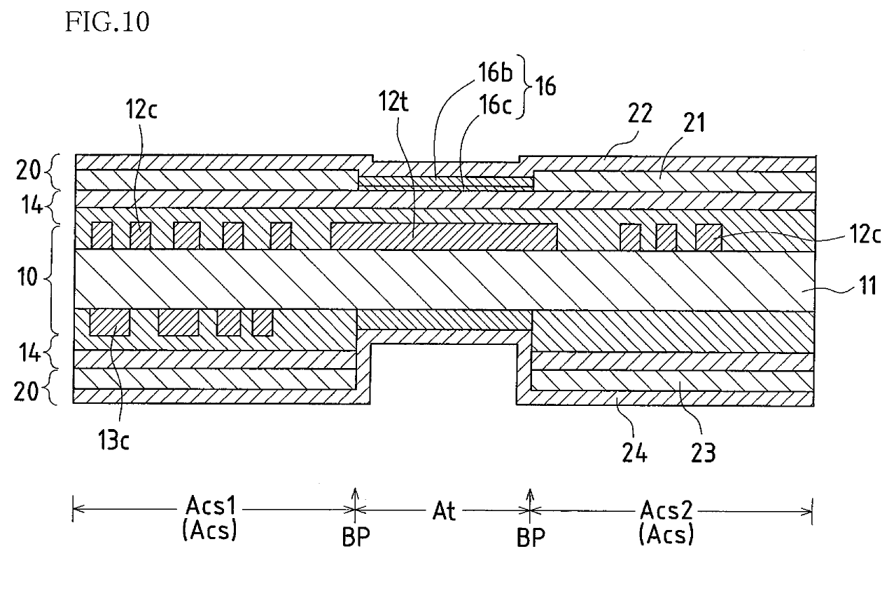

A method for manufacturing a multilayer printed wiring board according to a second embodiment will be described with reference to FIG. 10.

FIG. 10 is a cross-sectional view that shows an overall state in which the first embodiment is applied to a folding-type multilayer printed wiring board, in a method for manufacturing a multilayer printed wiring board according to a second embodiment of the present invention.

The method for manufacturing a multilayer printed wiring board according to the second embodiment is basically the same as in the first embodiment, but differs in that this method is applied to a multilayer printed wiring board (common name: folding-type multilayer printed wiring board) in which a plurality of layered circuit pattern portions Acs (a layered circuit pattern portion Acs1 and a layered circuit pattern portion Acs2; when not necessary to distinguish these, referred to as a layered circuit pattern portion Acs) are connected and linked at the lead pattern portion At. Below, mainly differing points will be described while appropriately citing the reference numerals of the first embodiment.

The basic steps are the same as in the first embodiment. The state shown in FIG. 10 is established by performing the inner layer circuit pattern formation step, the resin film affixing step, and the outer layer base material layering step. Because the layered circuit pattern portion Acs1 and the layered circuit pattern portion Acs2 are connected to each other at the lead pattern portion At, a border position BP is formed at two locations corresponding respectively to both edges of the lead pattern portion At. At the border positions BP, the end portions of the outer layer adhesive layers 21 and 23 are positioned, and corresponding to the end portions of the outer layer adhesive layers 21 and 23, the resin film 16 is affixed to the face where the lead pattern 12t has been formed.

After the base material layering step, same as in the first embodiment, the outer layer circuit patterns 22c and 24c are formed in the outer layer pattern formation step. At this time, the outer layer conductor layer 22 layered corresponding to the resin film 16 and the outer layer conductor layer 24 layered corresponding to the inner layer insulating base material 11 are removed. In other words, it is possible to establish the state shown in FIG. 9 of the first embodiment.

After the outer layer pattern formation step, by executing outer shape processing same as in the first embodiment, it is possible to manufacture a multilayer printed wiring board in which a plurality of layered circuit pattern portions Acs are connected at the lead pattern portion At.

The same operation effects as in the first embodiment are obtained in the second embodiment. Also, the uses (scope of applicability) of the multilayer printed wiring board can be expanded.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A method for manufacturing a multilayer printed wiring board, the multilayer printed wiring board being provided with a flexible inner layer base material having an inner layer circuit pattern portion and a lead pattern portion extended from the inner layer circuit pattern portion, and an outer layer base material having an outer layer circuit pattern portion layered on the inner layer circuit pattern portion, the method comprising:
an inner layer pattern formation step of patterning a conductor layer of the inner layer base material to form an inner layer circuit pattern of the inner layer circuit pattern portion and a lead pattern of the lead pattern portion,
a resin film affixing step of affixing a resin film to the lead pattern portion,
an outer layer base material layering step of layering and fastening to the inner layer base material an outer layer adhesive layer disposed corresponding to the inner layer circuit pattern portion and an outer layer conductor layer disposed corresponding to the inner layer base material,
an outer layer pattern formation step of patterning the outer layer conductor layer to form an outer layer circuit pattern portion corresponding to the inner layer circuit pattern portion, and
a resin film peeling step of peeling away the resin film from the lead pattern portion.

2. The method for manufacturing a multilayer printed wiring board according to claim 1, wherein an end portion of the resin film is disposed at or to the outside of a border of the lead pattern portion.

3. The method for manufacturing a multilayer printed wiring board according to claim 1, wherein the resin film comprises
a heat-resistant resin material layer that is tolerant of the application of heat and pressure in the outer layer base material layering step, and
a film adhesive layer that is fastened to a face that faces the lead pattern portion of the heat-resistant resin material layer and is tolerant of the application of heat and pressure in the outer layer base material layering step, and is peeled away from the lead pattern portion in the resin film peeling step.

4. The method for manufacturing a multilayer printed wiring board according to claim 3, wherein the heat-resistant resin material layer is polyimide resin, and the film adhesive layer is formed with acrylic resin.

5. The method for manufacturing a multilayer printed wiring board according to claim 3, wherein the resin film has a thickness of several μm to several tens of μm.

6. The method for manufacturing a multilayer printed wiring board according to claim 1, wherein after the resin film affixing step, pretreatment for the outer layer base material layering step is performed.

7. The method for manufacturing a multilayer printed wiring board according to claim 1, further comprising
a through hole formation step of forming one or more through holes for connecting layers, the through hole formation step being provided between the outer layer base material layering step and the outer layer pattern formation step.

8. The method for manufacturing a multilayer printed wiring board according to claim 1, wherein the outer layer conductor layer layered on the resin film in the outer layer pattern formation step is removed.

9. The method for manufacturing a multilayer printed wiring board according to claim 2, wherein the resin film comprises
a heat-resistant resin material layer that is tolerant of the application of heat and pressure in the outer layer base material layering step, and
a film adhesive layer that is fastened to a face that faces the lead pattern portion of the heat-resistant resin material layer and is tolerant of the application of heat and pressure in the outer layer base material layering step, and is peeled away from the lead pattern portion in the resin film peeling step.

10. The method for manufacturing a multilayer printed wiring board according to claim 2, wherein after the resin film affixing step, pretreatment for the outer layer base material layering step is performed.

11. The method for manufacturing a multilayer printed wiring board according to claim 2, further comprising
a through hole formation step of forming one or more through holes for connecting layers, the through hole formation step being provided between the outer layer base material layering step and the outer layer pattern formation step.

12. The method for manufacturing a multilayer printed wiring board according to claim 2, wherein the outer layer conductor layer layered on the resin film in the outer layer pattern formation step is removed.
